(19) United States
(12) Patent Application Publication
(10) Pub. No.: US 2011/0167423 A1
(43) Pub. Date: Jul. 7, 2011

(54) Intelligent Keying Center Workflow Optimization

(75) Inventors: Piotr Zupinski, Mt. Prospect, IL (US); Robert Raphael Salinas, Sachse, TX (US); Coty Tyler Cherrix, Atlanta, GA (US); Joseph John Bonetti, Garland, TX (US)

(73) Assignee: Bank of America Corporation, Charlotte, NC (US)

(21) Appl. No.: 12/683,482

(22) Filed: Jan. 7, 2010

(51) Int. Cl. G06F 9/46

(52) U.S. Cl. 718/102

(57) ABSTRACT

A system and method for an intelligent keying center workflow optimization is disclosed. In accordance with one embodiment of the present disclosure, a method comprises receiving a plurality of work units and determining one or more item attributes associated with each of the work units. The method also includes selecting one of the plurality of work units to process. The method further includes determining one or more agent attributes associated with each of a plurality of agents. Additionally, the method includes selecting, with a workflow manager, an agent from the plurality of agents to process the selected work unit, based at least in part on the determined item attributes associated with each of the received work units and the determined one or more agent attributes. The method also includes transmitting the selected work unit to the selected agent.

### TECHNICAL FIELD

The present invention relates generally to workflow management, and more particularly to an intelligent keying center workflow optimization.

### BACKGROUND

Enterprises include multiple transaction and document management systems to support daily activities. Some enterprises require agents to either manually key information from electronic images or correct information previously captured by other means. Agents responsible for entering information into computer systems may be dispersed across the enterprise and are managed by leaders from different lines of businesses. Thus, coordinating and managing optimal workflow remains a challenge for enterprises.

### SUMMARY

In accordance with the present disclosure, the disadvantages and problems associated with prior systems and methods for intelligent keying center workflow optimization have been substantially reduced or eliminated.

In accordance with one embodiment of the present disclosure, a method comprises receiving a plurality of work units and determining one or more item attributes associated with each of the work units. The method also includes selecting one of the plurality of work units to process. The method further includes determining one or more agent attributes associated with each of a plurality of agents. Additionally, the method includes selecting, with a workflow manager, an agent from the plurality of agents to process the selected work unit, based at least in part on the determined item attributes associated with each of the received work units and the determined one or more agent attributes. The method also includes transmitting the selected work unit to the selected agent.

In accordance with another embodiment of the present disclosure, a system comprises a capture system operable to receive a plurality of work units from a customer and transmit the plurality of work units to a gateway. The gateway is operable to receive the plurality of work units from the capture system and transmit the plurality of work units to a workflow manager. The workflow manager is operable to receive the plurality of work units from the gateway and determine one or more item attributes associated with each of the work units. The workflow manager is also operable to select one of the plurality of work units to process and determine one or more agent attributes 46 associated with each of a plurality of agents. The workflow manager is also operable to select an agent from the plurality of agents to process the selected work unit, based at least in part on the determined item attributes associated with each of the received work units and the determined one or more agent attributes. Additionally, the workflow manager is also operable to transmit the selected work unit to the selected agent.

In accordance with yet another embodiment of the present disclosure, an apparatus is operable to receive a plurality of work units, determine one or more item attributes associated with each of the work units, select one of the plurality of work units to process, and determine one or more agent attributes associated with each of a plurality of agents. The apparatus is further operable to select an agent from the plurality of agents to process the selected work unit, based at least in part on the determined item attributes associated with each of the received work units and the determined one or more agent attributes. The apparatus is further operable to transmit the selected work unit to the selected agent.

In accordance with yet another embodiment of the present disclosure, a tangible computer readable medium comprises logic, the logic operable, when executed on a processor, to receive a plurality of work units. The logic is further operable to determine one or more item attributes associated with each of the work units, select one of the plurality of work units to process, determine one or more agent attributes associated with each of a plurality of agents. The logic is further operable to select an agent from the plurality of agents to process the selected work unit, based at least in part on the determined item attributes associated with each of the received work units and the determined one or more agent attributes. The logic is additionally operable to transmit the selected work unit to the selected agent.

Technical advantages of certain aspects of the present disclosure include optimizing processing of work units. An optimized schedule work unit processing facilitates the reduction or elimination of overtime worked by agents and the downtime of agents. Thus, by intelligently processing and scheduling work units, aspects of the present disclosure reduce costs for enterprises, while maximizing efficiency of agents working at processing sites. Additionally, agents receive work units which they are capable of processing, thus reducing errors associated with the processing of work units. As a result, particular embodiments of the present disclosure provide numerous operational benefits. Nevertheless, particular embodiments may provide some, none, all or additional technical advantages.

### BRIEF DESCRIPTION OF THE DRAWINGS

For a more complete understanding of the present invention and its advantages, reference is now made to the following description taken in conjunction with the accompanying drawings, in which:

FIG. 1 illustrates a workflow management system in accordance with particular embodiments of the present disclosure;

FIG. 2 illustrates the workflow manager illustrated in FIG. 1 in more detail, including aspects of the present disclosure; and

FIG. 3 is a flow chart illustrating a particular operation of the refinancing system of FIG. 1 in accordance with particular embodiments of the present disclosure.

### DETAILED DESCRIPTION

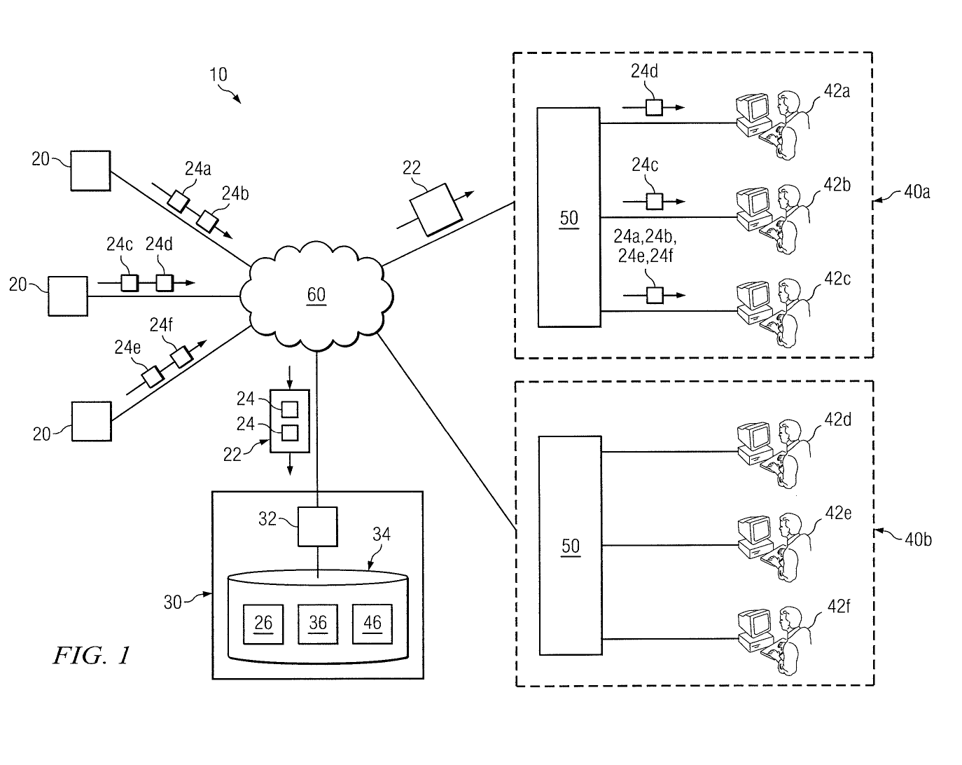

FIG. 1 illustrates a workflow management system 10 in accordance with particular embodiments of the present disclosure. System 10 includes capture systems 20, gateway 30, processing sites 40 and workflow manager 50. Capture systems 20, gateway 30, and workflow manager 50 may be communicatively coupled by network 60. System 10 is generally operable to optimize workflow scheduling in order to minimize overtime and downtime for agents 42 processing work units 24. To optimize workflow scheduling, gateway 30 receives batches 22 that include work units 24 from capture systems 20. Gateway 30 determines to which processing site 40 to transmit batches 22. Workflow manager 50 located at processing site 40 receives batches 22 from gateway 30, and transmits work units 24 to agents 42 based on item attributes 26 associated with work units 24 and agent attributes 46 associated with agents 42.

Capture systems 20 represent any device operable to receive work unit 24 for processing in system 10. In particular embodiments, capture system 20 represents an image Automatic Teller Machine (ATM), a Remote Image Capture (RIC), a retail lockbox, a wholesale lockbox, and/or a remote deposit. Capture system 20 transmits work unit 24 to gateway 30. In some embodiments, capture system 20 scans and transmits an electronic image of work unit 24. In such embodiments, work unit 24 may refer to an electronic image of a tangible work unit 24. In some embodiments, capture system 20 securely stores a tangible work unit 24 for later retrieval by an operator of system 10. In some embodiments, capture system 20 forms one or more batches 22, and each batch 22 includes a plurality of work units 24. In such embodiments, capture systems 20 transmit work units 24 to gateway 30 in batches 22. In general, however, capture systems 20 transmit work unit 24 to gateway 30 in any appropriate manner.

Work unit 24 represents any financial instrument that includes data and/or information suitable to be entered and/or processed in system 10. For example, in some embodiments, work unit 24 represents a personal check, a business check, a cashier's check, a teller's check, a wire transfer request, an electronic funds transfer request and/or a bond coupon. Each work unit 24 may include associated item attributes 26. In particular embodiments, item attributes 26 includes an item type (such as, for example, personal check, wire transfer request, bond coupon, etc.), a payee name, a payor name, an amount payable, a date payable, a payee account number, a payor account number, a routing number, a relative priority, skill level, estimated time to complete, and a deadline to complete. An estimated time to complete represents an average amount of time an agent 42 possessing the requisite skill level takes to complete processing associated with the particular work unit 24. A deadline to complete represents a time to complete the particular work unit 24. Deadline to complete may be expressed in absolute or relative terms. For example, item attributes 26 may indicate that a deadline to complete an associated work unit 24 is 5 p.m. Item attributes 36 may additionally or alternatively indicate that a deadline to complete an associated work unit 24 is 30 minutes from the time agent 24 receives the particular work unit 24. A skill level of work unit 24 represents a particular skill required to process an associated work unit 24. For example, some agents 42 may possess the skill required to process work units 24 having an item type of wire transfer request, while other agents 42 do not. Relative priority indicates a relative processing order in case of conflict with another work unit 24. In particular embodiments, agents 42 may enter, key in, or otherwise process item attributes 26 associated with work units 24. Additionally, batch 22 represents a grouping of work units 24. Work units 24 may be grouped into batch 22 according to one or more common characteristics. For example, in some embodiments, capture system 20 groups work units 24 according to payor name, work unit type, and/or payee name. In general, however, work units 24 may be grouped into batch 22 in any suitable manner.

Gateway 30 receives batches 22 and/or work unit 24 and selects a processing site 40 to process work units 24. Gateway 30 selects a processing site 40 to process one or more work units 24 based on item attributes 26, agent attributes 46, and/or site attributes 36. Gateway 30 comprises any suitable combination of hardware and/or software implemented in one or more modules to provide the described functions and operations. In some embodiments, gateway 30 comprises a general-purpose personal computer (PC), a Macintosh, a workstation, a Unix-based computer, a server computer, or any suitable processing device. In some embodiments, the functions and operations described above may be performed by a pool of multiple gateways 30. A particular gateway 30 may comprise memory 34 and processor 32.

Memory 34 comprises any suitable arrangement of random access memory (RAM), read only memory (ROM), magnetic computer disk, CD-ROM, or other magnetic or optical storage media, or any other volatile or non-volatile memory devices that store one or more files, lists, tables, or other arrangements of information. Although FIG. 1 illustrates memory 34 as internal to gateway 30, it should be understood that memory 34 may be internal or external to gateway 30, depending on particular implementations. Memory 34 may be separate from or integral to other memory devices to achieve any suitable arrangement of memory devices for use in system 10.

Memory 34 stores batches 22, work units 24, item attributes 26, site attributes 36, and/or agent attributes 46. Memory 34 also stores logic 36. Logic 36 generally comprises rules, algorithms, code, tables, and/or other suitable instructions for receiving work units 24, selecting an appropriate processing site 40 for processing work units 24, and transmitting work units 24 to workflow manager 50 at a selected processing site 40.

Memory 34 is communicatively coupled to processor 32. Processor 32 is generally operable to execute logic 36 to receive work units 24, select an appropriate processing site 40 for processing work units 24, and transmit work units 24 to workflow manager 50 at a selected processing site 40. Processor 32 comprises any suitable combination of hardware and software implemented in one or more modules to provide the described function or operation.

Processing sites 40a and 40b (which may be collectively referred to as “processing sites 40” or individually as “processing site 40”) represent a collection of agents 42 and workflow manager 50. In some embodiments, processing site 40 represents a tangible location where agents 42 process work units 24. In some embodiments, processing site 40 represents a logical grouping of agents 42 processing work units 24 via network 60. In particular embodiments, processing site 40 is associated with site attributes 36. Site attributes 36 may include, but are not limited to, a location of processing site 40, a time zone associated with processing site 40, a number of agents 42 associated with processing site 40, a number of agents 42 available to accept work units 24 at processing site 42, and/or a skill set of agents 42 associated with processing site 42. Although FIG. 1 illustrates an embodiment of system 10 that includes two processing sites 40, system 10 may, in general, include any appropriate number of processing sites 40.

Agents 42a, 42b, 42c, 42d, 42e, and 42f (which may collectively be referred to as “agents 42” or individually as “agent 42”) process work units 24 at processing site 40. For purposes of this description, processing refers to typing information associated with work unit 24 into a computer associated with agent 42. In particular embodiments, more than one agent 42 may enter information for a particular work unit 24. For example, a particular work unit 24 may be transmitted to agent 42a for processing. Once agent 42a finishes processing the particular work unit 24, workflow manager 50 may transmit work unit 24 to agent 42b for further processing. Moreover, in particular embodiments, agents 42 possess different skill types. For example, a skill type includes, for example, the speed at which agent 42 enters data from work unit 24, the ability to work with a particular type of work unit 24, and/or the ability to process one or more item attributes 26 associated with work units 24. In some embodiments, agents 42 possess more than one skill type. In particular embodiments, each agent 42 is associated with agent attributes 46. Agent attributes 46 include, but are not limited to, one or more skill type(s) possessed by agent 46, an availability of agent 46, one or more processing site(s) 40 at which agent 42 is located, and/or an efficiency level agent 42 possesses for a particular type of process associated with work unit 24. Agent attributes 46 may also include an estimated time until overtime, and an estimated downtime. An estimated time until overtime represents an amount of time a particular agent 42 may work until he or she is due overtime pay. An estimated downtime represents an amount of time during which agent 42 does not process work units 24.

Workflow manager 50 receives work units 24 and/or batches 22 from gateway 30 and selects one or more agents 42 to process the received work units 24. In particular embodiments, workflow manager 50 selects one or more agents 42 to process work units 24 based, at least in part, on item attributes 26, site attributes 36, and/or agent attributes 46. In particular embodiments, workflow manager 50 selects agents 42 to process work units 24 in order to minimize overtime worked by agents 42 and minimize downtime of agents 42 (e.g., a time during which agent 42 is not processing any work units 24).

Network 60 may represent any number and combination of wireline and/or wireless networks suitable for data transmission. Capture systems 20, gateway 30, and workflow managers 50 are communicatively coupled via one or more networks 50. In particular embodiments, agents 42 may communicatively couple to processing sites 40 via network 60 and/or workflow manager 50. Network 60 may, for example, communicate internet protocol packets, frame relay frames, asynchronous transfer mode cells, and/or other suitable information between network addresses. Network 60 may include one or more intranets, local area networks, metropolitan area networks, wide area networks, cellular networks, all or a portion of the Internet, and/or any other communication system or systems at one or more locations.

In an exemplary embodiment of operation, system 10 optimizes workflow scheduling by transmitting work units 24 to appropriate agents 42 for processing. In general, work units 24 are received at capture systems 20 and transmitted to gateway 30. Gateway 30 selects an appropriate processing site 40 to process work units 24. Gateway 30 transmits work units 24 to workflow manager 50 located at the selected processing site 40. Once received at workflow manager 50, workflow manager 50 selects one or more agents to process work units 24. Workflow manager 50 may select agents 42 based, at least in part, on item attributes 26, site attributes 36, and/or agent attributes 46. By selecting agents 24 based on the relevant item attributes 26, site attributes 36, and/or agent attributes 46, system 10 processes work units 24 to minimize overtime work by agents 42 and to minimize inactivity time experienced by agents 42.

In a particular embodiment of operation, a customer deposits work units 24a, 24b, 24c, 24d, 24e, and 24f in capture systems 20. Customer may deposit work units 24 in capture system 20 on a daily, weekly, and/or monthly basis. As discussed above, work unit 24 represents a personal check, a cashier's check, a teller's check, a remittance, a bond coupon, and/or any other appropriate financial instrument. In some embodiments, capture system 20 scans work unit 24 as an electronic image and transmits work unit 24 as an electronic image to gateway 30. Capture system 20 may transmit work units 24 to gateway 30 individually or as grouped in batches 22.

Moreover, capture system 20 may transmit work units 24 as they are received, or may be stored for later transmission at a predetermined time. In general, however, capture system 20 transmits work units 24 to gateway 30 at any appropriate time and in any appropriate manner.

Once gateway 30 receives work units 24, gateway 30 may select an appropriate processing site 40 to process work units 24. Particular embodiments of system 10 include a plurality of processing sites 40, each processing site 40 including agents 42 that process work units 24. Gateway 30 may select a particular processing site 40 to process work units 24 based on relevant factors. Gateway 30 may select processing site 40 based on item attributes 26 associated with work units 24, site attributes 36 associated with processing site 40, and/or agent attributes 46 associated with agents 42 located at a relevant processing site 40. As one example, site attributes 36 associated with processing site 40a indicate that all agents at processing site 40a are currently busy processing previously transmitted work units 24. Site attributes 36 associated with processing site 40b indicate that some agents at processing site 40b are not currently processing previously transmitted work units 24. Based on the site attributes 36, gateway 30 may transmit work units 24 to processing site 40b. As another example, item attributes 26 associated with work units 24 indicate a skill level of typing in a supplemental entry from a check stub invoice within two minutes is required. Agent attributes 46 associated with agents 42 at processing site 40a indicate that agents 42 at processing site 40a possess a skill level of typing in a supplemental entry from a check stub invoice within two minutes, while agent attributes 46 associated with agents 42 at processing site 40b indicate that agents 42 at processing site 40b possess a skill level of typing in a supplemental entry form a check stub invoice within five minutes. Thus, based on agent attributes 46 and item attributes 26, gateway 30 transmits work units 24 to processing site 40a. In general, however, gateway 30 may select a processing site 40 based on any item attributes 26, site attributes 36, agent attributes 46, a combination thereof, or any other relevant factors, considerations and/or variables.

Gateway 30 transmits work units 24 to workflow manager 50 at the selected processing site 40. Workflow manager 50 selects, based, at least in part, on item attributes 26 associated with the received work units 24 and agent attributes 46 associated with agents 42 at processing site 40, one or more agents 42 to process the received work units 24. Workflow manager 50 receives work units 24a, 24b, 24c, 24d, 24e, and 24f, each associated with a corresponding item attributes 26a, 26b, 26c, 26d, 26e, and 26f. Workflow manager 50 receives work units 24a, 24b, 24c, 24d, 24e, and 24f at 2:30 p.m. Item attributes 26a indicate that workflow unit 24a has a work type of check entry, a deadline of 30 minutes, and an estimated completion time of 5 minutes. Item attributes 26b indicate that workflow unit 24b has a work type of check entry, a deadline of 30 minutes, and an estimated completion time of 5 minutes. Item attributes 26c indicate that workflow unit 24c has a work type of supplemental entry, a deadline of 4:00 p.m., and an estimated completion time of 45 minutes. Item attributes 26d indicate that workflow unit 24d has a work type of supplemental entry, a deadline of 3:00 p.m., and an estimated completion time of 30 minutes. Item attributes 26e indicate that workflow unit 24e has a work type of supplemental entry, a deadline of 5:30 p.m., and an estimated completion time of 30 minutes. Item attributes 26f indicate that workflow unit 24f has a work type of check entry, a deadline of 30 minutes, and an estimated completion time of 5 minutes. Agent attributes 46a, 46b, and 46c associated with corresponding agents 42a, 42b, and 42c, indicate that all agents 42 are available, and possess the skill level to process supplemental entries and check entries. Accordingly, workflow manger 50 may distribute work units 24a, 24b, 24c, 24d, 24e, and 24f to agents 42a, 42b, and 42c in the following manner. Agent 42a receives work unit 24d. Its estimated completion time is 30 minutes with a deadline of 3:00 p.m. Agent 42a completes processing work unit 24d by its deadline of 3:00 p.m. Agent 42b receives work unit 24c. Its estimated completion time is 45 minutes with a deadline of 4:00 p.m. Agent 42b completes processing work unit 24c by its deadline of 4:00 p.m. Agent 42c receives work units 24a, 24b, 24e, and 24f. Agent 42c may complete work units 24a, 24b, 24e, and 24f within the deadline indicated by item attributes 26a, 26b, 26e, and 26f.

In some embodiments, a particular agent 42 at processing site 40a is not available to process a particular work unit 24 within the deadline indicated by item attributes 26 associated with the particular work unit 24. For example, workflow manager 50 may have two work units 24 with the same estimated completion time and deadline (as indicated by item attributes 26) to distribute to a single agent 42. In such case, workflow manager 50 transmits one of the conflicting work units 24 to workflow manager 50 at processing site 40b. Workflow manager 50 may also transmit one of the conflicting work units 24 to gateway 30, whereupon gateway 30 transmits the received work unit 24 to an appropriate workflow manager 50 in accordance with the operation described above.

Based on the foregoing operations, system 10 may optimize scheduled processing of work units 24. An optimized schedule of processing work units 24 facilitates the reduction or elimination of overtime worked by agents 42 and the downtime of agents 42. Thus, by intelligently processing and scheduling work units 24, system 10 reduces costs for operators, while maximizing efficiency of agents 42 working at processing sites 40. Additionally, agents 42 receive work units 24 for which they are capable of processing, thus reducing errors associated with the processing of work units 24. As a result, system 10 provides numerous operational benefits. Nevertheless, particular embodiments of system 10 may provide some, none, all, or additional operational benefits.

Modifications, additions, or omissions may be made to system 10 without departing from the scope of the present disclosure. For example, when a component of system 10 determines information, the component may determine the information locally or may receive the information from a remote location. As another example, in the illustrated embodiment, capture systems 20, gateway 30, and workflow manager 50 are represented as different components of system 10. However, the functions of capture system 20, gateway 30, and workflow manager 50 may be performed by any suitable combination of one or more servers or other components at one or more locations. In the embodiment where the various components are servers, the servers may be public or private servers, and each server may be a virtual or physical server. The server may include one or more servers at the same or at remote locations. Also, capture system 20, gateway 30, and workflow manager 50 may include any suitable component that functions as a server. Additionally, system 10 may include any number of capture systems 20, gateways 30, and workflow managers 50. Any suitable logic may perform the functions of system 10 and the components within system 10.

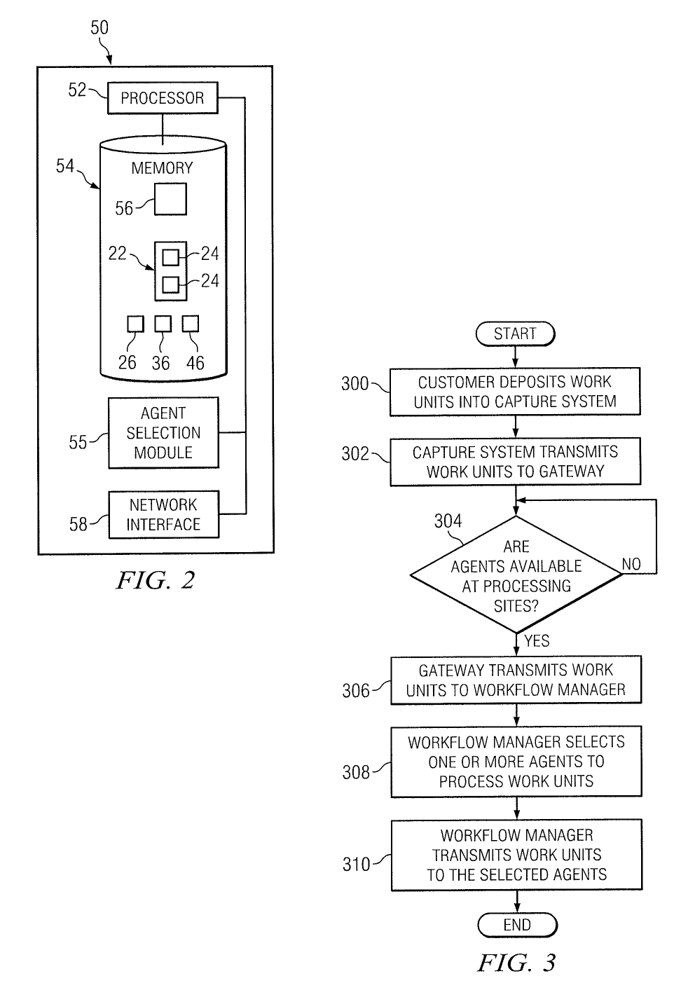

FIG. 2 is a block diagram illustrating aspects of workflow manager 50 discussed above with respect to FIG. 1. As discussed above, workflow manager 50 receives batch 22, selects work unit 24 included in batch 22 to process, selects an appropriate agent 42 to process the selected work unit 24, and transmits the selected work unit 24 to the selected agent 42. Workflow manager 50 includes processor 52, memory 54, agent selection module 55, logic 56, and network interface 58.

Workflow manager 50 comprises any suitable combination of hardware and/or software implemented in one or more modules to provide the described functions and operations. In some embodiments, workflow manager 50 may comprise a general-purpose personal computer (PC), a Macintosh, a workstation, a Unix-based computer, a server computer, or any suitable processing device. In some embodiments, the functions and operations described above may be performed by a pool of multiple workflow managers 50.

Memory 54 comprises any suitable arrangement of random access memory (RAM), read only memory (ROM), magnetic computer disk, CD-ROM, or other magnetic or optical storage media, or any other volatile or non-volatile memory devices that store one or more files, lists, tables, or other arrangements of information such as batch 22, work units 24, item attributes 26, site attributes 36, agent attributes 46. Memory 54 may also store a list of agents 42 at processing site 40 at which workflow manager 50 is located and a list of agents 42 at other processing sites 40. Although FIG. 2 illustrates memory 54 as internal to workflow manager 50, it should be understood that memory 54 may be internal or external to workflow manger 50, depending on particular implementations. Memory 54 may be separate from or integral to other memory devices to achieve any suitable arrangement of memory devices for use in system 10.

Memory 54 is further operable to store logic 56. Logic 56 generally comprises rules, algorithms, code, tables, and/or other suitable instructions for receiving, storing, and transmitting work units 24. Logic 56 also comprises instructions for selecting an appropriate agent 24 to process work units 24.

Memory 54 is communicatively coupled to processor 52. Processor 52 is generally operable to execute logic 56 to receive work units 24 (whether individually or included as part of batch 22), select a particular work unit 24 to process, select an particular agent 42 to process a selected work unit 24, and transmit the selected work unit 24 to the selected agent 42. Processor 52 may select a particular work unit 24 and/or agent 42 based on any appropriate factors, including item attributes 26, site attributes 36, and/or agent attributes 46. Processor 52 comprises any suitable combination of hardware and software implemented in one or more modules to provide the described function or operation.

Agent selection module 55 selects an appropriate agent to process work units 24. Agent selection module 55 may select a particular work unit 24 from batch 22 to process. The selection may be based on item attributes 26 associated with each of the work units 24 included in batch 22, and/or agent attributes 46 associated with agents 42 located at processing site 40. Further, agent selection module 55 selects, based, at least in part, on item attributes 26 associated with the received work units 24 and agent attributes 46 associated with agents 42 at processing site 40, one or more agents 42 to process the received work units 24. Once a particular agent 42 is selected, agent selection module 55 may transmit the selected work unit 24 to the selected agent 42. In particular embodiments, agent selection module 55 transmits the selected work unit 24 to agent 42 by transmitting work unit 24 to a computer associated with agent 42. In particular embodiments, no agents 42 may be available to process work units 24 or a conflict may exist between two work units 24. In such embodiments, agent selection module 55 may transmit work unit 24 to another workflow manager 50 located at a different processing site 40. Agent selection module 55 may additionally or alternatively transmit work unit 24 to gateway 30, which may select an appropriate workflow manager 50 to process work unit 24. In particular embodiments, agent selection module 55 comprises logic 56 executing on processor 52.

Network interface 58 communicates information with network 60. For example, network interface 58 receives batch 22 and/or work units 24 from gateway 30 through network 60. As another example, network interface 58 communicates work unit 24 to agents 42 through network 60. Network interface 58 represents any port or connection, real or virtual, including any suitable hardware and/or software that enables workflow manager 50 to exchange information with network 60, gateway 30, agent 42, workflow mangers 50, and/or or other components of refinancing system 10.

FIG. 3 is a flow diagram illustrating an operation in accordance with a particular embodiment of system 10. In the illustrated example, operation begins at step 300, with a customer depositing one or more work units 24 into capture system 20. As discussed above, in particular embodiments, capture system 20 represents an image Automatic Teller Machine (ATM), a Remote Image Capture (RIC), a retail lockbox, a wholesale lockbox, and/or a remote deposit. In particular embodiments, capture system 20 scans an electronic image of work unit 24.

At step 302, capture system 20 transmits work unit 24 to gateway 30. Capture system 20 may group particular work units 24 into bundle 22 and transmit bundle 22 to gateway 30. In particular embodiments, capture system 20 transmits work unit 24 to gateway 30 as work units 24 are received. In some embodiments, capture system 20 stores work units 24 until transmission at a predetermined time (such as, for example, daily, week, and/or monthly). In general, however, capture system 20 may transmit work unit 24 to gateway 30 at any appropriate time.

At step 304, gateway 30 determines whether agents 42 at one or more respective processing sites 40 are available to process work units 24. Using site attributes 36 associated with the one or more respective processing sites 40 and/or agent attributes 46 associated with agents 42, gateway 30 determines whether agents 42 are available to process work units 24. It should be noted that the availability of agents 42 includes, for example, whether the agent is not currently processing work units 24, whether agent 42 possesses the skill type to process the item type identified in item attributes 26, whether agent 42 can complete processing of work unit by the deadline identified in item attributes 26, and/or according to any other relevant considerations, variables, and/or factors. If agents 42 are available, operation proceeds with step 306. If agents 42 are not available at any processing sites 40, gateway 30 may retain work units 40 in memory 34, and periodically determine whether agents 42 are available to process work units 24 at one or more processing sites 40. In some embodiments, gateway 30 determines which processing site 40 will have agents coming available soonest, and transmit work units 24 to workflow manager 50 at the relevant processing site 40.

At step 306, gateway 30 transmits work units 24 to workflow manager 50 located at the processing site 40 determined to have agents available in step 304. As discussed above, gateway 30 transmits work units 24 at any appropriate time. Additionally, gateway 30 may transmit work units 24 to workflow manager 50 through network 60.

At step 308, workflow manager 50 selects one or more agents 42 to process work units 24. Workflow manager 50 may select agents 42 based, at least in part, on item attributes 26 associated with the received work units 24, site attributes 36 associated with processing site 40 in which workflow manager 50 is located, and/or agent attributes 46 associated with agents 42 located in processing site 40. Workflow manager 50 may select, based on agent attributes 46, agents 42 that possess the requisite skill identified in item attributes 26. Workflow manager 50 may also select, based on agent attributes 46 and item attributes 26, one or more agents 42 that can complete processing of work units 24 by the deadline specified in relevant item attributes 26. By selecting agents 24 based on the relevant item attributes 26, site attributes 36, and/or agent attributes 46, system 10 processes work units 24 to minimize overtime work by agents 42 and to minimize inactivity time experienced by agents 42.

At step 310, workflow manager 50 transmits the relevant work units 24 to the selected agents 42. In particular embodiments, transmitting the relevant work units 24 to the selected agents 42 comprises workflow manager 50 transmitting the relevant work units 24 to a computer associated with the selected agents 42. Once received, agents 42 may process work units 24 by entering data included in one or more work units 24 into a computer associated with agent 42.

The steps illustrated in FIG. 3 may be combined, modified, or deleted where appropriate, and additional steps may also be added to those shown. Additionally, the steps may be performed in any suitable order without departing from the scope of the present disclosure.

Although the present disclosure has been described with several embodiments, numerous changes, variations, alterations, transformations, and modifications may be suggested to one skilled in the art, and it is intended that the present disclosure encompass such changes, variations, alterations, transformations, and modifications as fall within the scope of the appended claims.

What is claimed is:

1. A method, comprising:
receiving a plurality of work units;
determining one or more item attributes associated with each of the work units;
selecting one of the plurality of work units to process;
determining one or more agent attributes associated with each of a plurality of agents;
selecting, with a workflow manager, an agent from the plurality of agents to process the selected work unit, based at least in part on:
the determined item attributes associated with each of the received work units; and
the determined one or more agent attributes; and
transmitting the selected work unit to the selected agent.

2. The method of claim 1, further comprising:
selecting a workflow manager from a plurality of workflow managers, each workflow manager associated with one of a plurality of processing sites, based at least in part on one or more site attributes associated with each of the plurality of processing sites, to receive the plurality of work units, wherein each of the plurality of processing sites comprises one or more of the plurality of agents.

3. The method of claim 1, wherein the one or more item attributes are selected from the group consisting of item type, skill level, estimated time to complete, and estimated deadline.

4. The method of claim 1, wherein the one or more agent attributes are selected from the group consisting of availability, skill set, efficiency, an estimated time until overtime, and an estimated downtime.

5. The method of claim 2, wherein the one or more site attributes are selected from the group consisting of time zone, number of associates, and availability of associates.

6. A system, comprising:
a capture system operable to:
receive a plurality of work units from a customer; and
transmit the plurality of work units to a gateway;
the gateway operable to:
receive the plurality of work units from the capture system; and
transmit the plurality of work units to a workflow manager;
the workflow manager operable to:
receive the plurality of work units from the gateway;
determine one or more item attributes associated with each of the work units;
select one of the plurality of work units to process;
determine one or more agent attributes associated with each of a plurality of agents; and
select an agent from the plurality of agents to process the selected work unit, based at least in part on:
the determined item attributes associated with each of the received work units; and
the determined one or more agent attributes; and
transmit the selected work unit to the selected agent.

7. The system of claim 6, further comprising:
a plurality of workflow managers;
a plurality of processing sites comprising one or more of the plurality of agents, wherein each of the plurality of workflow managers is associated with one of the plurality of processing sites;
wherein the gateway is further operable to:
select a workflow manager from the plurality of workflow managers, based at least in part on one or more site attributes associated with each of the plurality of processing sites, to receive the plurality of work units.

8. The system of claim 6, wherein the one or more item attributes are selected from the group consisting of item type, skill level, estimated time to complete, and estimated deadline.

9. The system of claim 6, wherein the one or more agent attributes are selected from the group consisting of availability, skill set, efficiency, an estimated time until overtime, and an estimated downtime.

10. The system of claim 7, wherein the one or more site attributes are selected from the group consisting of time zone, number of associates, and availability of associates.

11. An apparatus, comprising:
a network interface operable to receive a plurality of work units; and
a processor coupled to the network interface, the processor operable to:
determine one or more item attributes associated with each of the work units;
select one of the plurality of work units to process;
determine one or more agent attributes associated with each of a plurality of agents;
select an agent from the plurality of agents to process the selected work unit, based at least in part on:
the determined item attributes associated with each of the received work units; and
the determined one or more agent attributes; and
transmit the selected work unit to the selected agent.

12. The apparatus of claim 11, wherein the processor is further operable to:
select a workflow manager from a plurality of workflow managers, each workflow manager associated with one of a plurality of processing sites, based at least in part on one or more site attributes associated with each of the plurality of processing sites, to receive the plurality of work units, wherein each of the plurality of processing sites comprises one or more of the plurality of agents.

13. The apparatus of claim 11, wherein the one or more item attributes are selected from the group consisting of item type, skill level, estimated time to complete, and estimated deadline.

14. The apparatus of claim 11, wherein the one or more agent attributes are selected from the group consisting of availability, skill set, efficiency, an estimated time until overtime, and an estimated downtime.

15. The apparatus of claim 12, wherein the one or more site attributes are selected from the group consisting of time zone, number of associates, and availability of associates.

16. A tangible computer readable medium comprising logic, the logic operable, when executed on a processor, to:
receive a plurality of work units;
determine one or more item attributes associated with each of the work units;
select one of the plurality of work units to process;
determine one or more agent attributes associated with each of a plurality of agents;
select, with a workflow manager, an agent from the plurality of agents to process the selected work unit, based at least in part on:
the determined item attributes associated with each of the received work units; and
the determined one or more agent attributes; and
transmit the selected work unit to the selected agent.

17. The computer readable medium of claim 16, wherein the logic is further operable to:
select a workflow manager from a plurality of workflow managers, each workflow manager associated with one of a plurality of processing sites, based at least in part on one or more site attributes associated with each of the plurality of processing sites, to receive the plurality of work units, wherein each of the plurality of processing sites comprises one or more of the plurality of agents.

18. The computer readable medium of claim 16, wherein the one or more item attributes are selected from the group consisting of item type, skill level, estimated time to complete, and estimated deadline.

19. The computer readable medium of claim 16, wherein the one or more agent attributes are selected from the group consisting of availability, skill set, efficiency, an estimated time until overtime, and an estimated downtime.

20. The method of claim 17, wherein the one or more site attributes are selected from the group consisting of time zone, number of associates, and availability of associates.
